(19) United States
(12) Patent Application Publication
(10) Pub. No.: US 2009/0164573 A1
(43) Pub. Date: Jun. 25, 2009

(54) METHOD FOR FORMING AD HOC SOCIAL NETWORKS IN TWO DIMENSIONAL COLLABORATION

(75) Inventors: Andrew J.F. Bravery, Wiltshire (GB); Martin Gale, Hampshire (GB); Darren M. Shaw, Fareham (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/960,927

(22) Filed: Dec. 20, 2007

(51) Int. Cl. G06F 15/16

(52) U.S. Cl. 709/204

(57) ABSTRACT

A method for networking and collaboration, the method includes: monitoring one or more communication systems for conversations of interest; identifying conversations of interest; introducing the user to the one or more conversations of interest; wherein the identification of one or more conversations of interest is made in response to parameters inputted by the user; and wherein the inputted parameters are matched to at least one of: tags and keywords associated with the conversations of interest.

### BACKGROUND OF THE INVENTION

1. Field of the Invention

The present invention relates generally to collaborative tools, and more particularly, to a method for extending two-dimensional collaborative tools, such as instant messaging (IM), to facilitate networking and collaboration on topics of common interest.

2. Description of the Related Art

In real world collaboration, a powerful means of building social networks is physically being in the same space (e.g., a conference room, restaurant, train, airplane, lounge) and overhearing a conversation. A common situation that arises for people, who are attending a conference, is their overhearing two people talking about a subject of interest, introducing themselves and subsequently carrying out collaboration. This powerful dynamic is hard to achieve, however, in today's world of virtualized work and telecommuting, where communities are often distributed and the occasions when people mix with those of common interests are relatively rare if they happen at all. Three dimensional (3-D) virtual world technologies, such as SecondLife® originated by Linden Lab, Inc., replicates physical dynamics and interactions with computer based graphics. The SecondLife® 3-D virtual world is created by residents (subscribers), and was established in 2003. Presently, the SecondLife® 3-D virtual world has millions of residents located around the globe. Virtual worlds or virtual environments generally take place in cyberspace on networks such as the Internet.

Among the features available to residents within the SecondLife® 3-D virtual world is the ability for “seeing” two other residents talking and “overhearing” their textual conversation in progress, and in effect replicating the real world dynamic.

### SUMMARY OF THE INVENTION

A method for networking and collaboration, the method includes: monitoring one or more communication systems for conversations of interest; identifying conversations of interest; introducing the user to the one or more conversations of interest; wherein the identification of one or more conversations of interest is made in response to parameters inputted by the user; and wherein the inputted parameters are matched to at least one of: tags and keywords associated with the conversations of interest.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method for extending two-dimensional collaborative tools, such as instant messaging (IM), to facilitate networking and collaboration on topics of common interest.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow chart for a method for extending two-dimensional collaborative tools, such as instant messaging (IM), to facilitate networking and collaboration on topics of common interest according to embodiments of the invention.

FIG. 2 illustrates a system for implementing embodiments of the invention.

FIG. 3 illustrates an exemplary conversational icon according to embodiments of the invention.

The detailed description explains the preferred embodiments of the invention, together with advantages and features, by way of example with reference to the drawings.

### DETAILED DESCRIPTION

Embodiments of the invention provide a means for extending two-dimensional collaborative tools, such as instant messaging (IM), to facilitate networking and collaboration on topics of common interest. Embodiments of the invention employ a mechanism for filtering the set of all collaborative conversations down to a specific subset of interest, and allow the user to participate. The invention extends the semantics of software applications, such as SecondLife®, by leveraging digital mediums to find conversations that may be of interest to a user without having to “physically” (or pseudo-physically if you will) walk up to people and only “hear” conversations in range. In addition, embodiments of the invention also apply purely to two rather than three dimensional mediums, such as instant messaging, and does not require the user to be “in another world” as SecondLife® does, although an object in a metaverse (online universe) environment may be constructed in SecondLife® to bring this capability into that world as well.

Embodiments of the invention are configured on instant messaging systems, with an online user community within a defined virtual space. The online user community might be as precise as the contents of a user's buddy list in an instant messaging client, clients connected to a physical network, or some other meta-data based flocking, such as a community of commonly tagged people (e.g., all people with a specific topic of interest). Flocking refers to the practice of grouping together a set of related tags (keywords) depending on how closely related they appear to be. Flocking is a common technique in applications such as weblogs, where people tag an entry with a set of keywords. Flocking is a visual way of representing how often words occur (for example, making them appear bigger and bolder in the flock), and their proximity indicates words that commonly appear alongside them.

With embodiments of the invention, participants in a conversation are able to set a privacy level for their conversation. For example, a private/public setting on the conversation may be set by the users, or in alternative embodiments a continuous “volume” scale for conversations may be implemented. The volume control adjusts the level of detail provided in a summary of an ongoing conversation. The summary information about the ongoing conversation is displayed through a user interface. The user interface provides the user with the “overhearing” paradigm, and allows other buddies to listen in and decide whether they wish to simply listen or join in to the conversation. The summary information of the conversation might be a full rolling transcript, or just the keywords distilled from the conversation. The summary information might be represented to the user in a visual medium by means of a dialog box, in a graphical user interface (GUI), when a mouse is rolled over the representation of the conversation.

Embodiments of the invention provide the user with a means for joining a conversation via the user interface. For example, the user may request to join a conversation by double clicking the representation of the conversation, and a request to join the conversation would be generated, and sent to the participants already in the conversation. The existing participants in the conversation may accept or reject the user request as they would in a standard instant messaging session.

Embodiments of the invention are able to seek out and find ongoing conversations of interest to a user on instant messaging networks. Embodiments of the invention employ methods of collating and highlighting recorded information according to interest profiles. For example, tagging systems allow users to associate words (tags) with addressable content (text, images, podcasts, video) according to their own view of the world, and then the aggregation of all user's tags is used as a searchable index so that content that has been tagged the same can be retrieved through search tools and data feeds. Similarly people can be tagged according to their expertise, interests or what they are known for and their personal or contact details can be retrieved alongside the other content.

Embodiments of the invention may also be used over voice communication or telephone networks configured with voice to text infrastructure or real time voice recognition systems. In the voice communication or the telephone networks, the conversation is not tagged, as the conversation is in process of occurring. However, some context can immediately be associated with the conversation by observing the parties involved in the conversation, and how the parties themselves are tagged. If the parties share common tagging information, there is a reasonable level of expectation that the conversation they are having will be about something related to their tagged information. Subsequently, the actual conversation itself may be searched for key words in order to gather context, and then provide a level of tagging of the ongoing conversation.

Embodiments of invention may be configured with a profiling mechanism, possibly in the form of a plugin to the instant messaging system. The user, acting as a potential eavesdropper, may set up a set of selections for which they will be alerted in response to conversations of interest that are occurring. The set of selections would allow the user (eavesdropper) to register their own tags of interest, and then have the system identify conversations that are occurring between parties associated with those tags or discussing the identified topics. The set of selections may be further tuned to identify specific people, and a specific subject matter of interest.

In order to address privacy concerns, parties may wish to exclude themselves completely from the conversation system of embodiments of the invention, in which case the plugin need not be installed, or if they would like to eavesdrop but not be eavesdropped on, then options would allow this when installing the plugin. Privacy settings may limit the people allowed to eavesdrop to buddies only, or limit or hide the full nature of the conversation, so that it is only possible to find out that a conversation happened on a subject of interest, and not the details related to the conversation.

In the event the system has identified an ongoing conversation of interest, the user may ask the conversation participants permission to join the conversation, either passively as an observer (eavesdropping), or actively as a participant. Conversations might even be conducted in the open, where eavesdropping is positively encouraged and access to the conversation would not need to be sought or granted. The open conversation is similar to a real-time exchange that might occur in a blog through commenting, but with a more immediate instant messaging based style to it, and a discovery mechanism that is tightly tuned to ensuring the conversation can be joined while it is active rather than discovered later when perhaps the heat or intensity has gone out of the debate.

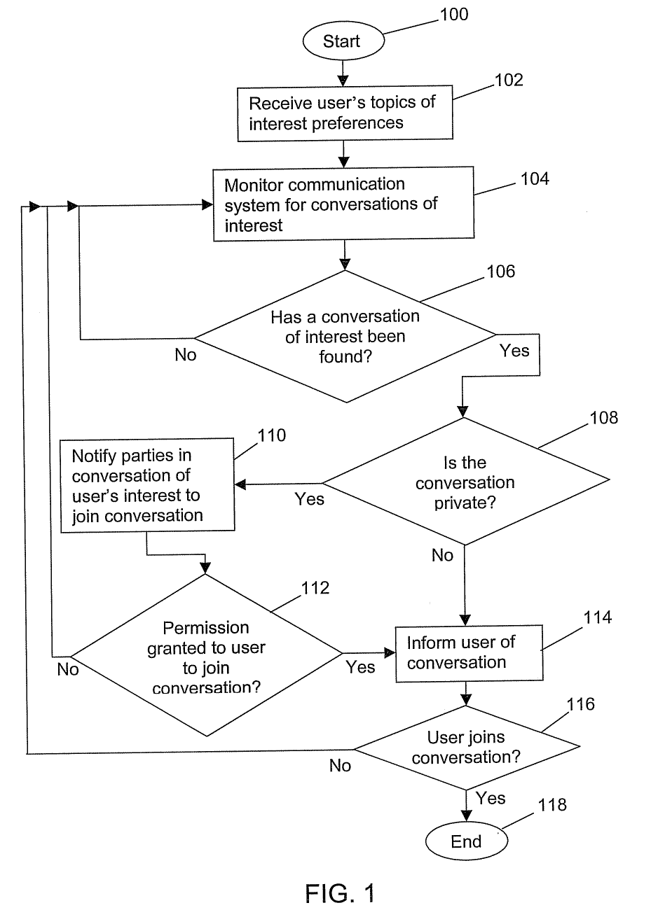

FIG. 1 illustrates a flow chart for a method for extending two-dimensional collaborative tools, such as instant messaging (IM), to facilitate networking and collaboration on topics of common interest according to embodiments of the invention. The method starts (block 100) with the collaborative tool receiving a user's topics of interest (block 102). In response to receiving the user's topics of interest, the communication system is monitored for the user's topics of interest (block 104). If a conversation of interest is found (decision block 106 is Yes), a determination is made if the conversation is private (decision block 108). If the conversation is private (decision block 108 is Yes), the parties in the conversation are notified of the user's interest in joining their conversation (block 110). If permission is not granted to the user to join the conversation (decision block 112 is No), the communication system is monitored again for the user's topics of interest (block 104). However, if permission is granted to the user to join the conversation (decision block 112 is Yes), the user is informed of the conversation (block 114). The user may choose to join the conversation (decision block 116 is Yes) and the process ends (block 118) with the user's entry into the conversation. If the user chooses to not join the conversation (decision block 116 is No), the communication system is monitored again for the user's topics of interest (block 104).

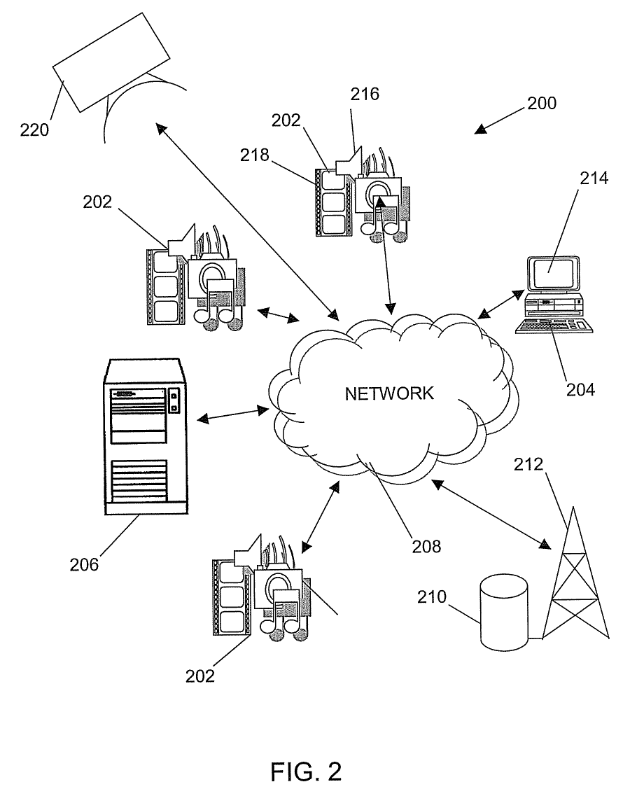

FIG. 2 illustrates an exemplary system 200 for facilitating networking and collaboration on topics of common interest according to embodiments of the invention. The system 200 includes remote devices in the form of multimedia devices 202, and desktop computer devices 204 configured with display capabilities 214 for implementing the GUI aspects of the invention described herein. The multimedia devices 202 may be mobile communication and entertainment devices, such as cellular phones and mobile computing devices that are wirelessly connected to a network 208. The multimedia devices 202 have video displays 218 and audio outputs 216 for implanting the GUI described herein. The network 208 may be any type of known network including a fixed wire line network, cable and fiber optics, over the air broadcasts, satellite 220, local area network (LAN), wide area network (WAN), global network (e.g., Internet), intranet, etc. with data/Internet capabilities as represented by server 206. Communication aspects of the network are represented by cellular base station 212 and antenna 210.

User profiles and databases for preferences for conversation subject content may be resident on the individual multimedia devices 202 and desktop computers 204, or stored within the server 206 or cellular base station 210. The software for running the determining and implementing user preferences for conversation subject content may be resident on the remote devices (202, 204), the server 206 or cellular base station 210.

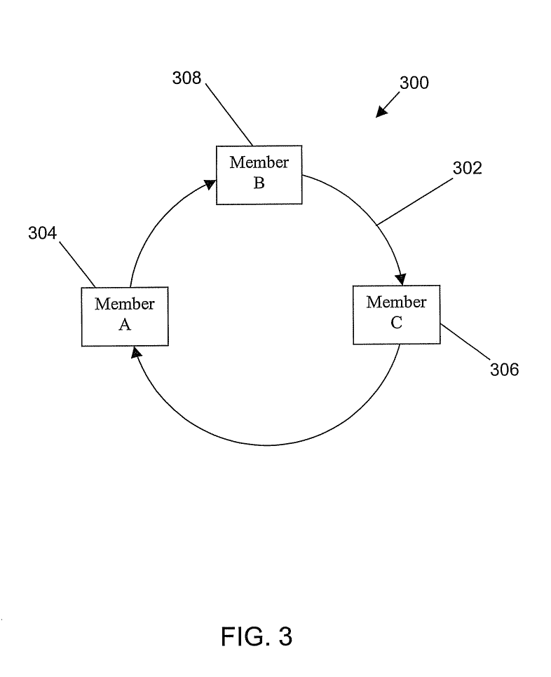

FIG. 3 is an exemplary icon for embodiments of the invention that represents a conversation in progress between two or more members of the online user community in a visual manner. In FIG. 3, the icon 300 for indicating a conversation in progress has a circle 302 with arrows to indicate conversational interaction between members (304, 306, 308). The user may click on the icon in their graphical user interface to be admitted into the conversation.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for networking and collaboration, the method comprising:
monitoring one or more communication systems for conversations of interest;
identifying one or more conversations of interest;
notifying a user of the identification of one or more conversations of interest;
introducing the user to the one or more conversations of interest;
wherein the identification of one or more conversations of interest is made in response to parameters inputted by the user; and
wherein the inputted parameters are matched to at least one of: tags and keywords associated with the conversations of interest.

2. The method of claim 1, wherein the method further comprises:
determining whether the identified conversations of interest are private or public;
wherein in response to a determination that the conversation of interest is private, a plurality of participants talking part in the conversation of interest are notified of the user's desire to join the conversation of interest; and
wherein the plurality of participants grant or deny the user's entry into the conversation of interest.

3. The method of claim 1, wherein the one or more communication systems are instant messaging (IM) systems.

4. The method of claim 1, wherein the one or more communication systems are voice communication or telephone networks configured with voice to text infrastructure or real time voice recognition systems; and
wherein tags associated with each of a plurality of participants in a conversation are used to determine if the conversation is of interest to the user.

5. The method of claim 1, wherein the one or more communication systems are configured to create a virtual environment;
wherein the virtual environment takes place in cyberspace in a metaverse over computer networks; and
wherein the virtual environment is configured for carrying out conversations of interest.
